(19) United States
(12) Patent Application Publication
(10) Pub. No.: US 2008/0195375 A1
(43) Pub. Date: Aug. 14, 2008

(54) Echo translator

(76) Inventors: Gideon Farre Clifton, London (GB); Martin William McDonough, Idahofalls, ID (US)

Correspondence Address: GIDEON CLIFTON, 4 NOTTINGHAM STREET, LONDON, WIU 5EQ, omitted

(21) Appl. No.: 11/704,677

(22) Filed: Feb. 9, 2007

(51) Int. Cl. G06F 17/28

(52) U.S. Cl. 704/4; 704/E11.001

(57) ABSTRACT

A method for translating from a first language to a second language, includes the selecting a category for the translation; selecting a theme for said translation based on the selected category; selecting a key phrase based upon a subject of the sentence to be translated;

selecting a first follow phrase related to the key phrase and corresponding to a predicate of the sentence or part thereof and selecting subsequent follow phrases to complete the sentence as necessary.

### BACKGROUND OF THE INVENTION

This invention relates generally to devices which are employed to facilitate learning and communication in foreign languages. More particularly, the present invention relates to electronic devices wherein the user interacts with the device to provide a responsive audio output.

There has recently been a proliferation of devices which employ speech and/or sound inputs and/or outputs to communicate useful information of various forms. A number of devices, for example, may provide various types of input techniques and employ electronic speech synthesizers which communicate with the user by means of synthesized speech. The communication by synthesized speech enhances learning effectiveness but cannot convey other attributes of language, emphasis and inflection, for example, without requiring additional electronic memory and circuit complexity.

A number of devices have been adapted in part to function in connection with learning and/or communicating in foreign language applications. One device is disclosed in Liu U.S. Pat. No. 5,480,306 which includes a language learning apparatus employs an optical code as the input medium. An optical code/bar code is associated with each of a number of word sentences, etc. Digitized pronunciations of the words and sentences are stored in electronic memory. Each word sentence entry is assigned a distinct optical code/bar code correlated accurately with the printed material as well as with a memory address. An optical code reader and a signal decoder circuit convert the optical code of the selected word sentence into an associated electrical signal which, in turn, is converted into a memory address pointing to the associated digitized sound that is stored in the electronic memory. The digitized sound data at the memory address is copied and converted to analog for broadcasting by a loudspeaker system. The digital sound data may comprise pronunciations in more than one language.

Glenn in U.S. Pat. No. 6,434,518 discloses a compact, hand-held electronic translator which functions to provide users with actual voice translations of selected word sentences. The translator includes a compact case. Memory modules are mountable to the top of the case and electrically connected thereto house electronic memory devices able to receive and store audio material and to make it available for retrieval and broadcasting as desired, without digital compression or conversion or voice synthesis techniques. Translations in male or female voices are stored in the modules as random access, read only memory, each in analog form with all the emphasis, inflection, nuances, etc. important to the learning of a foreign language. A booklet forms part of each memory module. The booklet contains base language word sentences and their stored translations. Modules can be removed and replaced by others offering different language pairs, subject matter or levels of difficulty.

### SUMMARY

The invention may be understood by reference to the following description taken in conjunction with the accompanying drawings, in which, like reference numerals identify like elements, and in which:

The Echo translator is a real voice language translator and phrase builder for computer mobile phones and handheld devices.

With the use of the phrase builder technology, the user of the present invention can speak, learn and instantly interact with anyone of any culture without prior knowledge of the foreign-language.

The language packs have been developed to be geared towards different language learning requirements.

The Echo language packs vary from basic, travel to extended learning and advanced applications to provide an on-device, personal and convenient alternative to classical forms of language education.

The Echo translator is based on an Echo mobile digital media platform which is a versatile environment and transport independent mobile digital media delegation and playback system which is designed to deliver a verity of rich media applications for e-learning media or travel application and other portable devices from mobile phones to PDAs and connected devices for example GPS navigation devices etc.

The Echo translator includes a phrase builder which provides the users of the Echo translator with the ability to dynamically select words or phrases from a category and collate a sentence which is translated and transmitted in real-time on the device to deliver an accurate phrase in terms of the target language SVO (subject, verb object) phrase order. The phrase builder is not limited to a predetermined number of phrases but can add phrases upon phrases to meet the needs of the user.

The Echo translator includes native language voices encoded at high compression ratios to deliver thousands of phrase combinations with one of the most developed speech codecs available to ensure accurate translation and a natural communication experience.

The Echo translator provides instant, real-time, simultaneous and phrase-sequential voice and text translation. The native real voices ensure an authentic and clear articulation for an easy, enjoyable and familiar translation method. The nonlinear presentation of the phrase combinations allows the user's to dynamically create phrases by selecting a button and seeing the corresponding translation. The phrase subject, verb and object in the order prescribed by the target language within a given subject category (for example drinks) is presented on a single screen.

The Echo translator may or may not require connection to the Internet except to receive program updates ( which are optional) or in order to function depending upon the capabilities of the target device.

### BRIEF DESCRIPTION OF THE DRAWINGS

Various other objectives, features and attendant advantages of the present invention will become fully appreciated as the it becomes better understood when considered in conjunction with the accompanying drawings, in which like reference characters designate the same or similar parts throughout the several views, and wherein:

FIG. 1 illustrates a list of potential choices;

FIG. 2 illustrates a block diagram of the system of the present invention;

FIG. 3 illustrates the system of the present invention;

FIG. 4 illustrates an application diagram of the present invention;

FIGS. 5a, b illustrate a first highlight display of the present invention;

FIGS. 6a, b, c, d illustrate a subsequent highlight displays of the present invention;

FIG. 7 illustrates a graphical user interface of the present invention;

FIG. 8 illustrates a flow chart of the present invention.

### DESCRIPTION

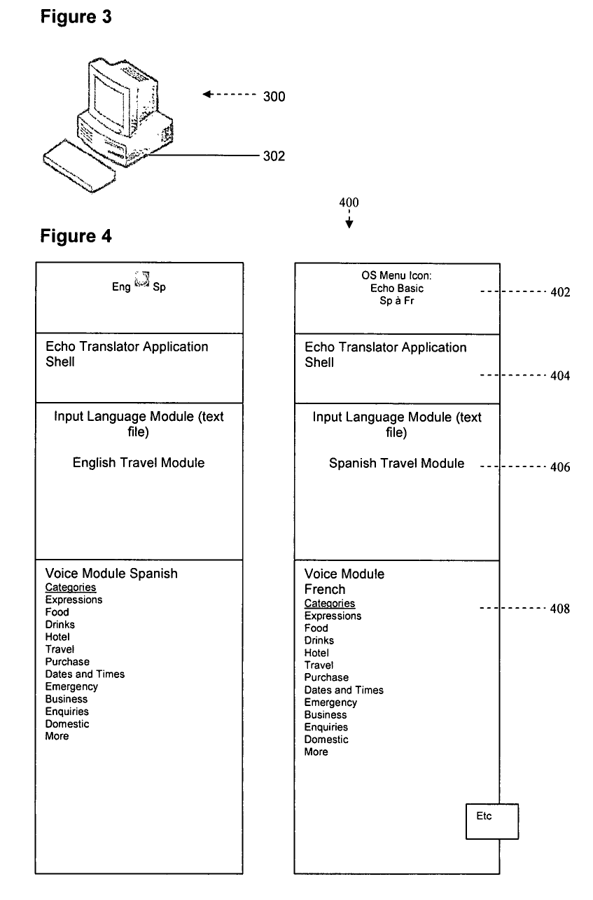

FIG. 3 illustrates a system 300 which allows users operate the Echo translator software and which includes a computer 302, and FIG. 2 shows a block diagram of the computer 302 of the system 300 shown in FIG. 3. Although FIG. 3 illustrates the computer 302, additional computers are within the scope of the embodiment. The system 300 includes output devices 220, such as, but not limited to, a display 222, and other output devices 223; input devices 215 such as, but not limited to, a mouse 216, a voice input device 217, a keyboard 218 and other input devices 219; removable storage 211 that may be used to store and retrieve software programs incorporating code that aids or executes the Echo translator or stores data for use with the Echo translator, or otherwise interacts with the Echo translator, such as, but not limited to, magnetic disk storage 212, optical storage 213 and other storage 214, a hard drive 210 that may be used to store and retrieve software programs incorporating code that aids or executes the Echo translator or stores data for use with the Echo translator, or otherwise interacts with the Echo translator and system components, such as those within dashed line 201, including but not limited to system memory 202, which includes BIOS (Basic Input Output System) 204, RAM (Random Access Memory) and ROM (Read Only Memory) 203, an operating system 205, application programs 206, program data 207, a processing unit 208, system bus 209, and network and or communications connections 224 to remote computers, an intranet which access is available to members of the organization and/or the Internet 225. Examples of such systems 100 includes without limitation personal computers, digital assistants, smart cellular telephones and pagers, dumb terminals interfaced to an application server and the like. The network includes various topologies, configurations, and arrangements of network interconnectivity components arranged to interoperability couple with enterprise, wide area and local area networks and include wired, wireless, satellite, optical and equivalent network technologies.

Echo Translator is an electronic phrase building software device which runs on computers and mobile or portable telephones. A sentence is built phrase by phrase until the sentence is complete. After the phase has been selected, the phase is translated into a predetermined foreign-language and then audibly reproduced instantly before the sentence is complete so that another person can understand the needs and desires of the user. A menu is selected based upon the communication that the user wishes to employ. For example, the menu may be based upon the sex of the communicator or the person being communicated to, sample and target languages, voice type (m/f) or voice speed.

Echo Phrase builder presents the user with a set of predetermined key phrases, follow phrases by category become indicated. After the selection of a predetermined phrase and a predetermined number of follow phrases which are independent of the predetermined phrase, the corresponding phrase or phrases in the foreign language are generated and then audibly reproduced by a prerecorded native human voice as each phrase is chosen so that the user can be understood by another person who does not speak the user's language. Independent means that there are many choices for phrases to be selected by the user. The predetermined phrases correspond to the subject and predicate or the subject, verb and object in the foreign language.

The predetermined phrases that the user places together when read or spoken as they have been placed together may be incomplete, but the highlight tool of the present invention links the predetermined phrases in a manner that produces an accurate and a correct phrase in the foreign-language.

The menu presented to the user presents the predetermined phrases in terms of subject, verb and predicate (verb and object) of a sentence, and each of these subject, verb and object are placed into an individual cell by the Echo translator. For example, I want a Sandwich.

The subject ‘I’ is placed into a first cell corresponding to the subject at a first period of time. The verb ‘want’ is placed into a second cell corresponding to the verb at a second period of time. The object ‘a Sandwich’ is placed into a third cell at a third period of time. The number of phrases that can be added to the sentence are practically limitless and are added at different periods of time. This allows the user to specify exactly what he desires by building the sentence phrase by phrase, and it is not necessary to be required to choose a prebuilt sentence which only approximates the user's desires.

SUBJECT

‘I,’

VERB

Other subjects, verbs and predicates found on the menu could have been chosen such as:

“WANT” or “I NEED” or “CAN I HAVE”

OBJECT

“A SANDWICH”

The word order of subject, verb and predicate may not be observed for other languages. When an English person learns French they are putting the words in a different order in the sentence. When that same person is learning German or a French person is learning German they are reworking the order again, but it is all the same information.

English:

I would like to buy an orange juice.

French:

I would like to buy a juice of orange.

Je voudrai acheter un jus d'orange.

German:

I would like an orange juice to buy.

At this point, the language is arbitrary because the correct sequence for a predetermined language is known, and the order in which the cells are translated can be determined by the language.

The Echo Phaselogic Phrase Builder delivers the phrase to the menu with its non linear ability to substitute any type of drink into the menu, and the user is not required to search through exhaustive lists in a book, but the user can simply glance at the menu on the screen to choose the desired drink by pressing a button corresponding to the display on the screen.

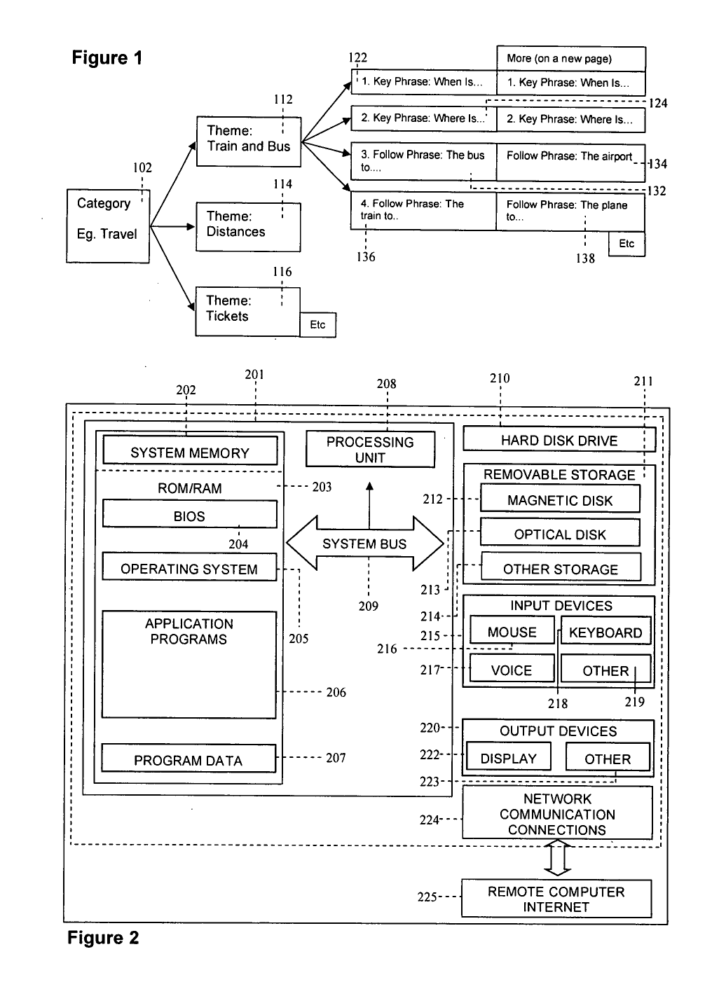

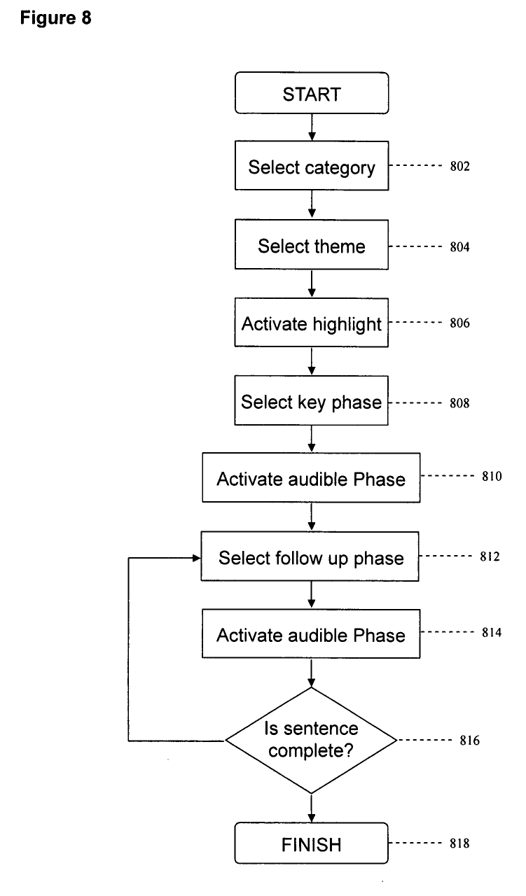

The predicate is the verb plus the object, and the subject is the element that is being talked about in the predicate. The predicate is everything that is not the subject in the sentence. The Echo Translator is the world's first system to provide a real time, non-linear simultaneous voice and text (or transliterated text) translation where the user has dynamic language access capabilities structured by the scenario in the category database. FIG. 8 illustrates the steps of the present invention. The category database sets the context for the available subjects in predicates. One example of a category in the category database 102 such as illustrated in FIG. 1 is travel. The display would show a list of possible categories. In step 802, the category is selected. Next, a theme is displayed based upon the category chosen. For example, a first theme 112 may be train and bus, a second theme 114 may be distances and a third theme 116 may be tickets. The user from the display may choose any theme that fits the need for translation as illustrated in step 804. The highlight function is activated in step 806. If the first theme 112 is chosen, the user should choose a key phrase from the display as in step 808. If the first theme 112 is chosen, then a first key phrase 122 is ‘when is’. A second key phrase 124 is ‘where is’. Additional key phrases can be offered to the user. The audio could be output as in step 810 or could be delayed.

Next, a choice of follow phrases is displayed on the display. The first follow phrase 132 is ‘the bus to’; the second follow phrase 134 is ‘the airport’; the third follow phrase 136 is ‘the train to’; and the fourth follow phrase 138 is ‘the plane to’.

The user decides if a second follow phrase is required by determining if the sentence is complete as in step 816.

If the user chooses the second key phrase 124 and the second follow phrase 134, the sentence could be ‘where is the airport’.

The audio output could be activated by the user in step 814.

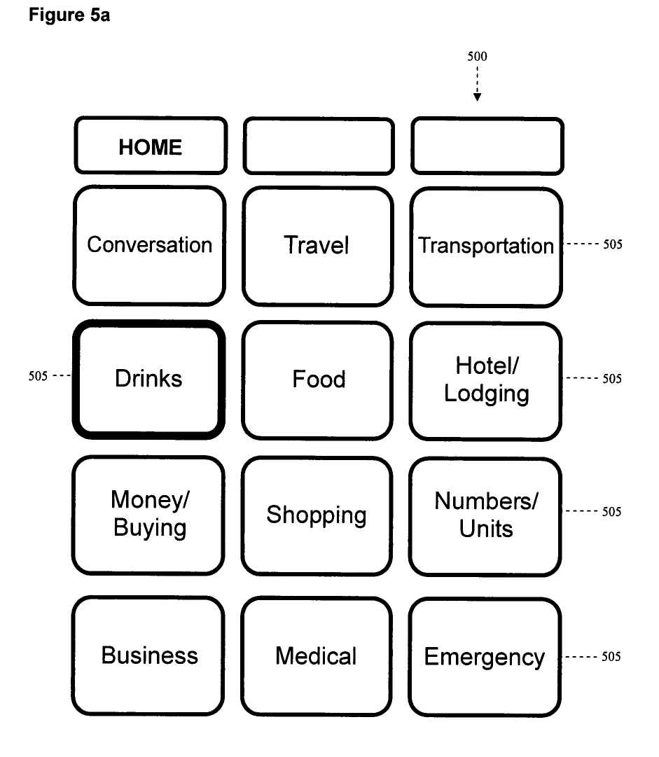

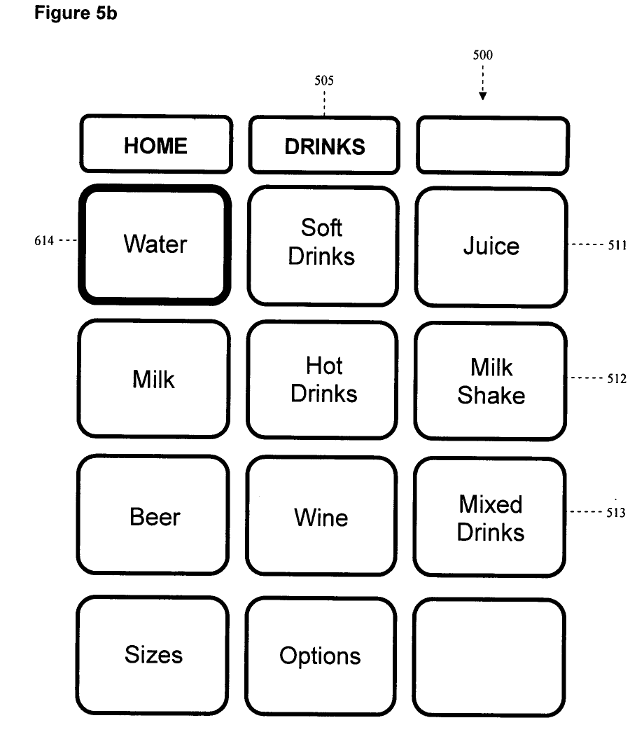

Echo translator is a voice translator application designed to run on portable computers including mobile phones. The control panel 500 of the Echo translator includes a matrix of graphic squares on the device display screen such as illustrated in FIG. 5a. The squares are laid out on the display screen to correspond to numerical keypad of a telephone is designed. In this way, each square can be chosen by the user by using the actual numeral keypad of the telephone.

The Echo translator may be used initially to enable communication in foreign languages where the user may have no previous experience in that language.

The user is presented with an intuitive control panel 500 which guides them through to the selection of their intended phrase. Through navigation of menus and the selection of words, the user can build a phrase which is audible and delivered through the device's loud speakers several different scenario based on categories (hotel, travel, shopping, emergency and medical etc).

Currently, with a traditional or electronic phrasebook, the user must first find the category and survey a linear list of possible phrases, the Echo translator allows the user to dynamically select the Subject, Verb and Object from a non-linear option list available on one screen within a category. The option list is not linear in this allows a more rapid selection of the SVO phrase elements that is possible with traditional electronic phrase books or similar devices

The highlight function aides the user in choosing a potential subject, verb or object, accelerating language learning through the cognitive process of building the subject and predicate from a non-linear list of options. The Echo translator is intuitive in that it does not require any training whatsoever. Anyone who can use the phone can use the application.

When a button is pressed the phone's screen and speakers will react to a pre-programmed function.

FIG. 5a illustrates the categories that may be available for the user. In the example above, the highlight 501 502, 503 504, 505 indicates category of transportation, hotel/lodging, numbers/units, emergency, drinks respectively. Furthermore, the highlight 505 is encircled as a recommendation. FIG. 5b shows the result of depressing the highlight 505 corresponding to drinks. The control panel 500 changes placing the highlight 505 corresponding to drinks in the top row of the control panel 500, and the remaining rows of the control panel 500 are highlighted to show a theme corresponding to potential drinks such as shown in highlight 511, 512, 513, 514 which correspond to choose, milkshake, mixed drinks and water. The highlight 514 which corresponds to water is encircled as a recommendation.

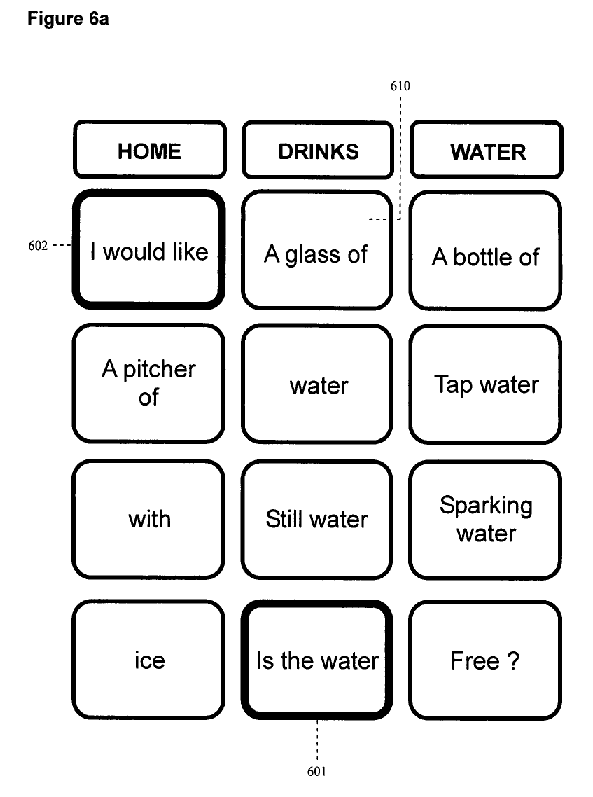

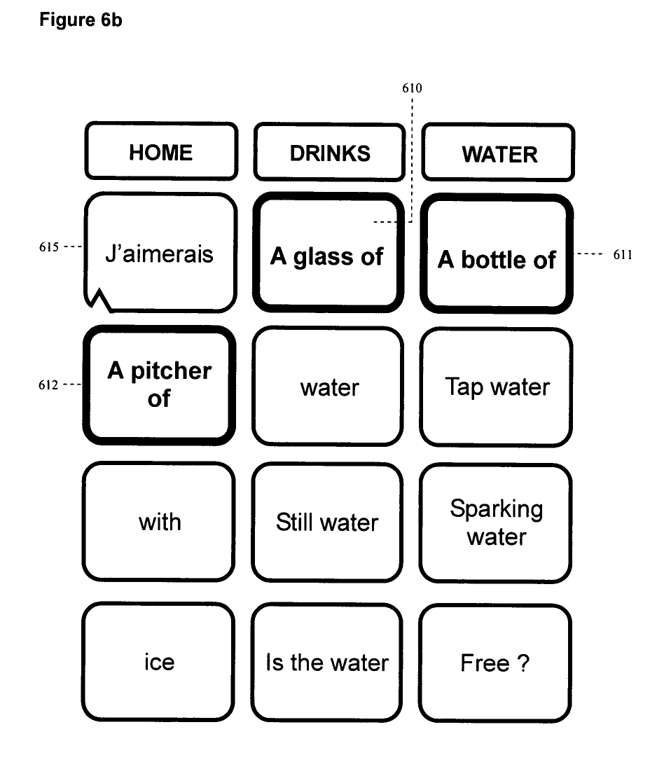

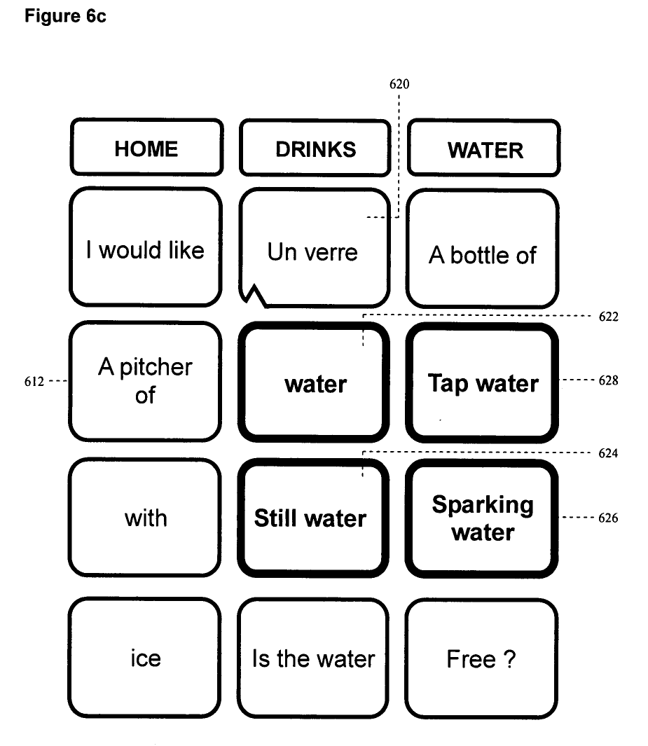

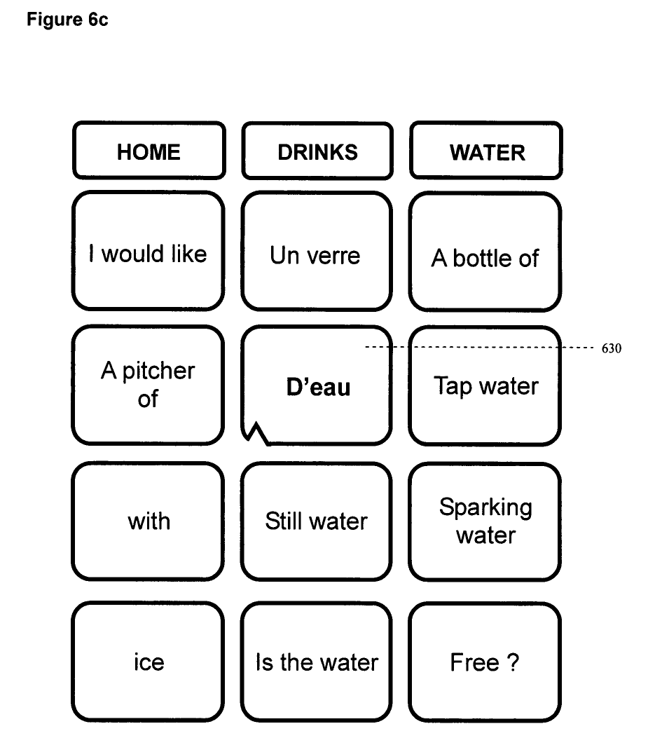

FIG. 6a illustrates the choices for the first phrase elements in the 601, 602. Depressing those buttons corresponding to highlight yields the text and voice translation in the target language, and the device would then indicate in FIGS. 6b which follow phase 610, 611, 612 could be said next in the target language for example, when translating from English to German.

FIGS. 5a,b illustrate that each square will contain a written word, phrase or icon. FIGS. 5a,b additionally illustrate that the written word, phrase or icon is superimposed over numbers of the dial of the cell phone or PDA so that either the square can be directly pressed or if the display does not react to being press, then the corresponding numbers on the cell phone can be used.

The response to pressing the square or pressing the corresponding number depends of the specific programming corresponding to the square when the button is pushed. The following individual reactions or reactions in combination could occur.
1. The entire screen could change to another screen to provide more options.
2. The box could expand and the text in the box could change to another text again to provide more options for the user.
3. A sound or video file could play. For example, a sound file in a foreign language could be played which corresponds to the sentence that has been built by the user.
4. The box could trigger another square or squares to highlight. For example, the square pressed could correspond to the subject or predicate (verb or object) desired by the user.
5. The icon in the box could change.

The Echo Language translation and Phrase builder is next described in terms of particular aspects of the Echo language translation and phrase builder.
1. Content for Echo translator language packs.
2. Chosen words and phrases.
3. Presentation of the content
4. Simple text-to-text translation.
5. Voice translation.
6. Highlight tool to build correct phrase.
7. Language packs
8. Categories in each language pack.
9. Layout and navigation of Echo language translator.
10. Number of languages
11. Transliteration.
12. Voice recognition.
13. Add peer content to service.
14. Sex of communicator and sex of communicatee.
15. Show video.
16. Speed of playback.
17. Change playback voice.

### 1. Content of Echo Translator Language Pack.

The translation pack includes the most common and useful words and phrases for each given category. The Travel Pro language pack was compiled from the most practical and useful phrases and were designed to require very little or no response from the person of the foreign language being addressed. However, this does not limit the ability of the foreign person being addressed to understand the audio or visual output from the Echo translator language pack. The foreign speaker will be able to easily understand what the person is saying or asking for.

The intent of the application is to first have the user of the Echo translator language pack to the communicate their needs effectively without needing to comprehend anything more than a simple yes or no from the party addressed. For example, can I have a glass of water?

### 2. Chosen Words and Phrases

The content for Travel Pro is a comprehensive amount of vocabulary so that the user can effectively arrive at a foreign destination with no knowledge of the foreign language and confidently arrive, travel and interact with local persons for the duration of their stay. The display of each of the FIGS. 6a,b is considered a page from the Echo translator. All pages are designed to be inclusive of the phrases in it. In other words, a complete phrase can be built on any one page. Additional pages may be accessed to provide additional flexibility. Although additional pages can be accessed for vocabulary, the Echo translator does not require access more than one page to build a phrase on the page. The user may wish to simply access one button to communicate.

### 3. Presentation of the Content.

The content will be presented in all lower case letters but could be presented in uppercase letters or a mix of lowercase letters and uppercase letters as the language syntax may dictate. The text may be indicated as transliteration into the source language alphabet to aid the user.

### 4. Simple Text-to-Text Translation.

These chosen words and phrases have been broken up in manner so that when pressed in the correct sequence indicated by the Highlight Function they form larger phrases and eventually complete sentences accurately communicated in terms of SVO in the target language.

At the very simple level on the translation page, a word will be written on the graphic square. When the number corresponding to that square is pressed the written word will b instantly translated and/or transliterated if the users so desires to the text of the foreign language.

### Non-Literal Translation

If the square contains more than one word like a phrase or part of a phrase then the text will instantly translate into the proper phrase equivalent of the foreign language. As not all words have the exact meaning, phrases are adjusted to be native to the listener. This is a process we call non-literal reverse translation.

Example: “I am hungry.” In Japanese literally means, “My belly is empty.”
The Echo translator provides both literal and nonliteral translations to deliver the correct meaning in the target language.

### 5. Voice Translation.

In addition to the translation of the text in the square on the screen, when the button is pressed there is a voice translation played out by the device's speaker or headset.

Each button has a collection of sound files associated with it. These are stored in sound databank on the terminal or available on the network which the device is accessing. One word may be used several times but stored only once or twice in the sound databank to allow for differing pronunciations or inflections of the same word.

### 6. Highlight Tool

Many languages are spoken in the same way.
Example: “Where is the exit?”

Many languages are also spoken in a different way for the same meaning.
Example: “The exit where is?”

“Where is” and “the exit” may be on different squares. The user should be abler to communicate with the same sentence structure as the language they are translating to.

The highlight tool guides the user on the correct path to ensure that the correct sentence structure is used in the target language being translated to. This process is called Echo phase logic.

### How the Highlight Tool Works.

When the user first opens a page containing language phrases, the part of the sentence that should be spoken first is highlighted as illustrated as elements 601, 602 in FIG. 6a. Once a highlighted phrase is chosen or pressed then the first part of the sentence is broadcast in the target language a second set of phrases such as elements in our 610, 611, 612 in FIG. 6b will illuminate. The button corresponding to element 615 is the written equivalent of the target language of the elements 601, 602 which were chosen. Only the last phrase spoken will highlight. Once a button from this set is pressed another set of words or phrases will reveal themselves. FIG. 6b illustrates three choices as elements 610, 611, 612 as the next follow phrase. Once the choices made and a button is pushed, the choice is displayed in the target language as illustrated as element 620 in FIGS. 6c. FIG. 6c illustrates additional follow-up phrases which are shown as elements 622, 624, 626, 628. The user selects one of these follow-up phrases 622, 624, 626, 628 and FIG. 6d illustrates the chosen follow-up phrase in the target language as element 630. This structure can be continue as many times until the phrase is complete. Normally, the set is 3 or 4 buttons and may be more or less.

### 7. Language Packs

The Echo translator has been divided into a series of language packs.
Echo Travel Pro
Advanced
Children's edition

### 8. Categories in Each Language Pack.

The Echo travel Pro pack consists of categories that are needed for basic communications and situations to yield yes/no responses or directions which may be understood in the users own (source) language.

### 9. Layout and Navigation of Echo

Echo is laid out in a way that the buttons 1-9*0 and # are used to navigate along with the joystick, the wheel or a touch-screen stylus. The first page of Echo will be a layout of Categories. When a category is pressed, the screen will change to a sub category section. From this sub section, a sub category is selected and a page of words for translation will be available. Additional categories, subcategories and subsections are within the scope of the invention. On all the pages, there are buttons.

By pressing back, the page will go back one to the previous page. The “more” button will illuminate when there are more translations under a certain sub category. By pressing ‘more’, a page will appear that relates directly to the previous page containing additional information on the chosen subject to allow additional phrases to be built into the sentence.

For hand sets with a screen too small to fit 12 buttons, a 9 button screen will be displayed, and the joystick can scroll down the page to access the final row.

Depending on the source language of translation, and the layout of the words, the phrases may be different. This layout is governed by the language being translated, and not the language being translated to.
Example: In Japanese language structure a person would say “The exit where is?” or “The football stadium where is?”

If an English speaking person is using the English to Japanese Echo then the words and phrases across and down the screen will be in the order of which the English person speaks.

The Echo translator continues adding phrases as many times as the sentence has words for. Normally the set is 3 or 4 buttons but may be more or less.

### 7. Language Packs

The Echo translator content has been divided into a series of packs.
Echo Travel Pro
Echo Advanced
Echo Children's edition

### 8. Categories in Each Language Pack.

The Echo travel Pro pack consists of categories that are universally important for all communications and situations. A sample of the categories is shown in FIG. 4.

### 9. Layout and Navigation of Echo

Echo is laid out in a way that the buttons 0-9, * and # are used to navigate along with the joystick, the wheel or a touch-screen stylus. The first page of Echo will be a layout of Categories. When a category is pressed, the screen will change to a sub category section. From this section, a sub category is selected, and a page of words for translation will be available. On all the pages after the main page, there will be the buttons

By pressing back the page will go back one to the previous page. The “more” button will only illuminate when there are more translations under a certain sub category. Buy pressing ‘more” a page will appear that relates directly to the previous page containing additional information on the chosen subject.

For hand sets with a screen too small to fit 12 buttons, a reduced button screen will be displayed, and the joystick can scroll down the page to access further rows were buttons.

Depending on language of translation the lay out of the words, the end phrases may be different. This layout is governed by the source language.
Example: In Japanese a person would say “The exit where is?” or “The football stadium where is?”

If an English speaking person is using the English to Japanese Echo Translator then the words and phrases will be in the layout order of the English language structure.

The important phrase in the above example would be ‘the football stadium’ and the following phrase would be ‘where is’

### Functionality

### 1) Echo Application Engine

Echo Application Engine populates the following variable system elements:
Os Application Icon and surrounding text e.g. Echo English to French
GUI Background Skin
Load up Splash Screen
Heading banner (e.g. ECHO logo)

Hotkey Text and Graphics
Text on Hotkeys e.g. phrase
Hotkey Background e.g. white b/g or Highlight and or jpg/.gif or similar
Hotkey Image

Hotkey Highlighter
The Order of which hotkeys are highlighted.
E.g. Hotkeys 1 through 3 are highlighted first until one of them is pressed, then keys 4 though 7 are highlighted until one of them is pressed then 8 etc (so on one Drinks page you could say [Can I] [Have] [a Coke] [with] [ice] [and] [lemon] [please] etc)
The highlight tool is just for guiding the user to the following phrase. User can choose not to follow highlighter.

Files Triggered by Hotkeys
Each hotkey plays audio (and later video) files.
Hotkeys can be queued to play in succession by the ECHO PHASELOGIC PHRASE BUILDER
Files played by each hotkey e.g. “Can I have” may be 2 or 3 sequential audio/video files or one audio/video file(s) by the ECHO PHASELOGIC PHRASE BUILDER
Audio Visual Files Database to enable Echo Translator Ltd to create a database of words and phrases or other sounds/videos. For example, input and output text and output audio for each language pack.

### User Settings

The User may select to view the:

TARGET LANGUAGE TEXT or

TARGET LANGUAGE TRANSLITERATED TEXT where the alphabet used is different (e.g. English to Greek, Chinese, Russian etc)

The user can select UPPER or lower case text or a combination of the two.

The user can turn the audio playback ON or OFF and select the sex of the communicator or communicates.

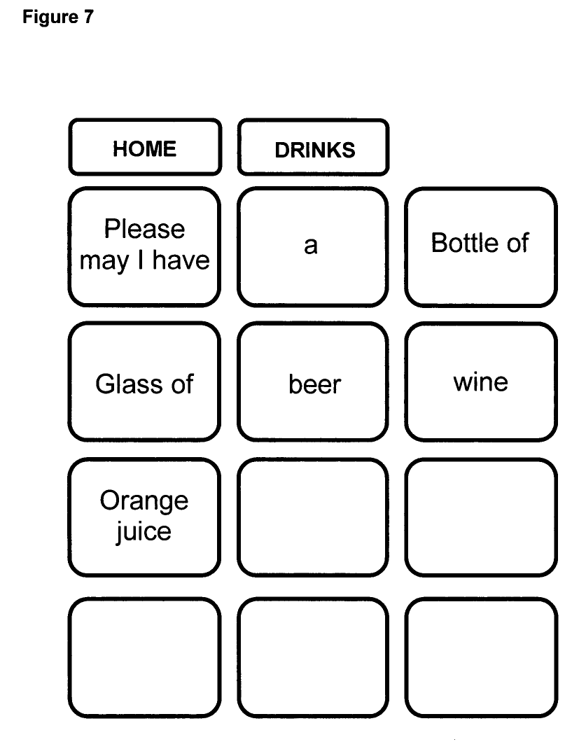

FIG. 7 illustrates a graphical user interface in accordance with the teachings of the present invention. The graphical user interface includes a TBC+OS Application Icon and Heading Banner. The graphical user interface of the present invention includes at least three elements to graphics: first a button background (usually clear); second a button ID (usually keypad number); and third a button text (the text of the translated or the file to be triggered). The Echo engine configures the number of buttons appearing on a screen.

FIG. 4 illustrates the Echo application diagram 400 which includes an OS menu icon 402 which shows for example that the Echo translator will translate from Spanish into French. The Echo application diagram 400 additionally includes the Echo translator application shell 404 and an input language module 406 which in the present example includes a Spanish travel module. The Echo application diagram 400 includes a voice module 408 which is for French and which includes various categories such as expressions, food, drinks, hotel, travel, purchase, date and time, emergency, business, inquiries, domestic and more.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

Additional System Functionality

The present invention can perform transliteration as well as translation or example ‘Hello’ in Russian is Privet when Transliterated into the Latin alphabet.

Peer content additions to local host terminals are permitted by the present invention. Users can add their own content to the application on their own device (302).

In addition, peer content additions to server (moderated and qualified at server side) are permitted by the present invention. Users can add their own content to the application on their own device (302), and other users can benefit from these additions.

The present invention can assist the user in receiving directions to a particular location. The present invention includes a directions category and has a ‘Receive Directions’ facility where translation is reversed allowing a communication partner to key directions in their own [Target Language] and corresponding audio translation is received in the Language Pack's [Source Language].

Users can ask for directions in a foreign (target) language, and then, the communicatee can respond with directions in the source language by selecting appropriate squares on the screen and the application displays and speaks the directions for the user.

The present invention may use voice Recognition to access Categories and Content (i.e. if user is on Home Page system looks for the word and matches it to a Category e.g. ‘Money’ will take user to Money/Buying Category If user is on Category page, System will match on any Content on the page).

In contrast with a complete voice recognition, the voice recognition element of the present application directs the user to an appropriate page.

The present invention uses image icons background pictures and text on buttons for additional clarification of the button's meaning for example Apple (text)+picture of an apple.

The present invention provides an enterprise edition for a vertical market, with industry specific vocabularies updateable via client extranet. This allows a user to select multiple target languages as may be required for example defense vocabularies, hotel vocabularies, medical vocabularies.

This type of service is available on dedicated devices designed specifically for the purpose and does not include telephones.

The Echo Translator can be run from the network or completely downloaded from the network to terminal and stored locally depending on the capabilities of the target device.

The user has the ability to store a user-defined selection of phrases from any number of categories in memory for access at any time.

The user can see all the phrase elements (subject, predicate) within a given Category or subcategory on one page and is therefore immediately able to begin creating a complete phrase or sentence. This approach enables a faster communication than any existing method and differentiates this product from others available. Our cognitive research shows that by presenting the Subject and Predicate separately the user is able to learn the language basics faster than using other methods.

The sex of user or communicatee may be set to only show translations for that scenario or alternatively without any predetermined setting, the application will indicate both for a male or female communicator and for a male or female communicatee.

The user may change the target voice in that the user may select a male or a female voice or that similar to a famous voice etc.

The user may select any Source and Target languages as may be required from the application.

1. A method for translating from a first language to a second language, comprising the steps of:
selecting a category for said translation;
if required, selecting a theme for said translation based on said selected category;
selecting a key phrase based upon a subject of the sentence to be translated;
selecting a further follow phrases corresponding to the predicate of the sentence as necessary.

2. A method for translating from a first language to a second language as in claim 1, wherein said translating of said first language to said second language is on a cell phone.

3. A method for translating from a first language to a second language as in claim 1, wherein said translating of said first language to said second language is on a PDA.

4. A method for translating from a first language to a second language as in claim 1, wherein said step of selecting said key phrase includes the step of indicating said key phrase in a first cell.

5. A method for translating from a first language to a second language as in claim 4, wherein said step of selecting said first follow phrase includes the step of indicating said first follow phrases in additional cells.

6. A method for translating from a first language to a second language as in claim 1, wherein the step of selecting a key phrase includes the step of highlighting choices of key phrases.

7. A method for translating from a first language to a second language as in claim 1, wherein the step of selecting a first follow phrase includes the step of highlighting choices of first follow phrases.

8. A method for translating from a first language to a second language as in claim 7, wherein the step of highlighting choices of said first follow phrases is performed after said key phrase is selected.

9. A method for translating from a first language to a second language as in claim 1, wherein said sentence is a nonliteral translation of said key phrase and said first follow phrase.

10. A method for translating from a first language to a second language as in claim 1, wherein said translating of said first language to said second language is on a mobile device.

11. A system including a computer for translating from a first language to a second language, comprising:
said computer selecting a category for said translation;
said computer selecting a theme for said translation based on said selected category; and/or
said computer forming a key phrase based upon a subject of the sentence to be translated;
said computer forming a first follow phrase related to said key phrase and corresponding to a predicate our part thereof of said sentence and repeating this for subsequent follow phrases as necessary.

12. A system including a computer for translating from a first language to a second language as in claim 11, wherein said translating of said first language to said second language is on a cell phone.

13. A system including a computer for translating from a first language to a second language as in claim 11, wherein said translating of said first language to said second language is on a PDA.

14. A system including a computer for translating from a first language to a second language as in claim 11, wherein said computer places said key phrase in a first cell.

15. A system including a computer for translating from a first language to a second language as in claim 14, wherein said computer places said first follow phrase in a second cell.

16. A system including a computer for translating from a first language to a second language as in claim 11, wherein said computer highlights choices of key phrases.

17. A system including a computer for translating from a first language to a second language as in claim 11, wherein said computer highlights choices of first follow phrases.

18. A system including a computer for translating from a first language to a second language as in claim 17, wherein said computer highlights said first follow phrases after said key phrase is selected.

19. A system including a computer for translating from a first language to a second language as in claim 11, wherein said sentence is a nonliteral translation of said key phrase and said first follow phrase.

20. A system including a computer for translating from a first language to a second language as in claim 11, wherein said translating of said first language to said second language is on a mobile device.
